(19) United States
(12) Patent Application Publication
(10) Pub. No.: US 2009/0124502 A1
(43) Pub. Date: May 14, 2009

(54) USE OF SULFURYL FLUORIDE AS A SPROUT INHIBITION AGENT

(75) Inventors: Suresh K. Prabhakaran, Mooresville, IN (US); Daniel J. Jenkins, Wildwood, MO (US); Andrew A. Ratteerman, Indianapolis, IN (US)

Correspondence Address: DOW AGROSCIENCES LLC, 9330 ZIONSVILLE RD, INDIANAPOLIS, IN, 46268, US

(73) Assignee: Dow AgroSciences LLC, Indianapolis, IN (US)

(21) Appl. No.: 12/265,751

(22) Filed: Nov. 6, 2008

Related U.S. Application Data
(60) Provisional application No. 61/002,298, filed on Nov. 8, 2007.

(51) Int. Cl. A01N 31/02; A01P 21/00

(52) U.S. Cl. 504/184

(57) ABSTRACT

This invention relates to the inhibition of sprouting of potato tubers by use of sulfuryl fluoride.

### CROSS-REFERENCE TO RELATED APPLICATIONS

This application claims priority from U.S. Provisional Application 61/002,298 filed on Nov. 8, 2007. The entire disclosure of which is hereby incorporated by reference.

### FIELD OF THE INVENTION

The present invention relates to the use of sulfuryl fluoride to inhibit sprouting in tubers, particularly in potatoes.

### BACKGROUND OF THE INVENTION

It is well known in the art to treat tubers such as potatoes with various chemicals having sprout-inhibiting properties. CIPC (chlorpropham, chlorprophame; chlor-IPC IRPAC name isopropyl 3-chlorocarbanilate; isopropyl 3-chlorophenylcarbamate; Chemical Abstracts name 1-methylethyl (3-chloro-phenyl)carbamate EEC no. 202-925-7) has been conventionally used for this purpose for about 40 plus years.

Potato tubers are often treated with a chemical sprout inhibitor in the storage season, and may receive another treatment of sprout inhibitor before being packaged for shipment to retail outlets. In the absence of chemical sprout inhibitors, the ultimate storage life is greatly reduced by loss of dormancy and early sprouting. Thus, virtually all potatoes stored mid and long term are treated with chemical sprout inhibitors.

Potatoes when being dug are frequently bruised, cut and/or abraded. These injuries to the potatoes oftentimes cause spoilage during shipment, storage and the like. A process known as suberization occurs naturally which tends to heal many of these injuries. However, whenever potatoes are stored, which occurs with a particularly large portion of potatoes harvested in any given year, if healing occurs slowly, a significant loss of potatoes can occur through spoilage. Early treatment with certain sprout inhibitors, such as CIPC, may retard the suberization process, thus contributing to the loss of potatoes through spoilage.

The main sprout inhibitors registered for use on potatoes are CIPC, maleic hydrazide (MH), and dimethylnaphthalene (DMN) and diisopropyl-naphthalene (DIPN). The two chemicals in combination (CIPC plus DIPN) appear to be more effective at lower concentrations than either of the two chemicals alone. Simultaneous application of CIPC and DIPN provides improved results over application of either sprout inhibitors separately.

For example, it is relatively common in the potato storage industry to treat potatoes with CIPC to prevent or retard development of sprouts in the potatoes. Even though untreated potatoes are stored at a cool temperature, for example, generally between about 36-52° F., sprouting does begin to occur after a month or more of storage. Storage of upwards of six to ten months is typical for stored potatoes. Thus, without treatment of a chemical such as CIPC, the stored potatoes become entangled in sprouts and the whole stored lot of potatoes may become economically useless. Although early treatment with CIPC could be advantageous for sprout inhibition purposes, application of CIPC is typically delayed until after suberization has occurred inasmuch as CIPC tends to retard suberization, resulting in accelerated rot and spoilage.

CIPC is typically applied in one or multiple applications to the tubers to be stored using thermal fogging techniques, sprays and powders. Conventional thermal fogging involves the application of CIPC into a stream of hot air or onto a hot surface of 550-1000° F., to produce a CIPC aerosol. The CIPC aerosol is circulated through potatoes piled in a potato storage building with the use of fans. Preferably the potatoes are turgid rather than soft when treated with the CIPC aerosol, since a pile of softened potatoes may be substantially compressed thereby impeding distribution of the aerosol. CIPC residue levels, will, however, typically decrease over time due to biodegradation, venting and atmospheric loss. To extend the effective sprout inhibiting capability of CIPC, further applications may be needed.

CIPC is used in significant quantities world wide and is capable of suppressing sprouts on stored tubers with the chemical ability to limit cell division. Increased rates, multiple applications, addition of substituted naphthalene chemistries coupled with strict storage management strategies have been implemented to help reduce sprout development in CIPC treated potatoes.

CIPC is known to be among the three agrichemicals found in highest concentrations in the diet of the average American (Gartrell et al., “Pesticides Selected Elements, and Other Chemicals in Adult Total Diet Samples, October 1980-March 1982”, J. Assoc. Off. Anal. Chem., 69:146-159, 1986), and it comprises over 90% of the total synthetic chemical residues found in U.S. potatoes (Gunderson, J. “FDA Total Diet Study, April 1982-April 1984, Dietary Intakes of Pesticides, Selected Elements, and Other Chemicals”, Assoc. Off. Anal. Chem., 71:1200-1209, 1988). Because of its persistence in the environment and potato tissue, concerns about its toxicity have been under review by the Environmental Protection Agency. CIPC is a derivative of ethylurethane, a well-known carcinogen, and it is not known whether CIPC, once ingested, is converted back to this parent compound (Mondy et al., “Effect of Storage Time, Temperature, and Cooking On Isopropyl N-(3-chlorophenol) Carbamate Levels in Potatoes”, J. Agric. Food Chem., 40:197-199, 1992). Because of its vulnerable position, the potato industry is in search of alternative agents for sprout control.

### DESCRIPTION OF THE INVENTION

The present invention provides an effective anti-sprouting treatment protocol that does not use CIPC and/or compliments the use of CIPC. More particularly, the present invention concerns a method for inhibiting sprouting of potato tubers comprising contacting the potato tuber with sulfuryl fluoride in an amount effective to inhibit sprouting. In addition to being used alone, sulfuryl fluoride can be used in concert with any other sprout inhibitor(s).

Sulfuryl fluoride is a non-flammable, non-corrosive gaseous material which boils at about −52° C. It is used as a fumigant for the control of nematodes, bacteria, molds and insects, particularly for the control of structural and post harvest pests such as Isoptera, Coleoptera, Lepidoptera and Blattodea. While phytotoxic, it has little effect on the germination of weed or crop seeds.

As used herein, the term “tuber” is inclusive of “potato tuber.” “Potato tuber” refers to the underground storage organ of the potato plant (Solanum tuberosum). The potato tuber is a modified stem and includes buds that can sprout and form new potato plants. The term “(potato) tubers” refers to both tubers generally and to potato tubers. Preferred potatoes include Russet Burbank, Ranger Russet, Umatilla Russet, Shepody, Norkotah Russet, Yukon Gold, Norchip, Gem Russet, Atlantic, Chipeta, Snowden, and Dark Red Norland.

The phrase “effective to inhibit sprouting” means that: (a) the number, and/or the weight, of stems (sprouts) growing from a defined number of (potato) tubers contacted with sulfuryl fluoride in accordance with the present invention is less than the number, and/or the weight, of stems growing from the same number of control (potato) tubers (of the same cultivar as the treated (potato) tubers) that were not contacted with a sprouting inhibitor; and/or (b) the average rate of growth of stems growing from a defined number of (potato) tubers contacted with sulfuryl fluoride in accordance with the present invention is less than the average rate of growth of stems growing from the same number of control (potato) tubers (of the same cultivar as the treated (potato) tubers) that were not contacted with a sprouting inhibitor. Such inhibition can be at any time as compared to the control. As understood by those in this field, the concept of inhibition is meaningful when control tubers show activity being inhibited in tubers contacted with sulfuryl fluoride. Another preferred measure of inhibition is a comparison between the total amount of “dormant+sprout up to 3 mm” tubers at, e.g., 50 days after harvest as compared to untreated control. Whichever measure is used, preferred amounts of inhibition include less than 1%, 1%, 3%, greater than 3%, 5%, 8%, 10%, 20%, 30%, etc. to 100%.

In general, the present invention includes any application of sulfuryl fluoride to tubers, and particularly includes application to potato plants in the field before the potatoes are harvested, and/or application after the potatoes are harvested but before they are stored, and/or application after the potatoes are in storage. In a preferred embodiment the sulfuryl fluoride is applied as a gas to harvested potatoes. Sulfuryl fluoride may also be first or subsequently applied after tubers (potatoes) have been harvested and stored for a sufficient period that bruises and cuts have healed, i.e., suberization has occurred. In another aspect of the invention, the sulfuryl fluoride is applied such that it inhibits sprouting during the potato shipping and distribution process.

In accordance with the foregoing, the present invention provides methods for inhibiting sprouting of potato tubers, the methods each including the step of contacting a potato tuber with an amount of sulfuryl fluoride that is effective to inhibit potato tuber sprouting. Typically, sulfuryl fluoride is applied simultaneously, or substantially simultaneously, to numerous harvested potato tubers. In the practice of the methods of the invention the sulfuryl fluoride is applied after the potato tubers have been harvested, but typically not later than the onset of sprouting. In some embodiments of the methods of the invention, the effective amount of sulfuryl fluoride is that amount sufficient to provide a dosage of from far less than 1 mg per/1 kg (parts per million) potato tubers to, e.g., 100 ppm, 500 ppm, and above. Preferred amounts include 0.01, 0.05, 0.1, 0.2, 0.3, 0.5, 1, 2, 3, 5, 8, 10, 15, 20, 25, 30, 35, 40, 50, 60, etc. ppm.

The instant invention includes a method of inhibiting the sprouting of stored tubers, especially potatoes, by applying a first sprout inhibiting chemical to the stored potatoes and then applying a second sprout inhibiting chemical at a later time, where at least one of the sprout inhibiting chemicals is sulfuryl fluoride makes up a part of the invention, the “second sprout inhibiting chemical” can include CIPC, MCPP, and DMN or DIPN, especially 2,6 diisopropyl naphthalene. Multiple materials may be applied together, or the time elapsed between application of the first and second chemical applications may be from a few moments to several months. The second chemical is generally applied at a time span when the efficacy of the sprout inhibiting characteristics of the first chemical is waning.

In accordance with the foregoing, in one aspect, the present invention provides methods for treating (potato) tubers, the methods each comprising the step of contacting a (potato) tuber with sulfuryl fluoride. Preferably the amount of sulfuryl fluoride is an amount effective to inhibit (potato) tuber sprouting. However, this is not required. For example, when sulfuryl fluoride is used together with another sprout inhibitor, the sulfuryl fluoride can be used in an amount less than that effective to inhibit potato tuber sprouting. Preferably, of course, the total amount of sprout inhibitor (i.e., the amount of sulfuryl fluoride and any additional sprout inhibitor(s)) is effective to inhibit potato tuber sprouting.

In the present invention, sulfuryl fluoride can also be used together with one or more antimicrobial and/or disease suppressing active agents, including products containing phosphites, hydrogen peroxide (dioxide), sodium chlorite, chlorine dioxide, thiobendazole, azoxystrobin, fludioxonil, and mancozeb.

In a preferred embodiment of the invention, sulfuryl fluoride is applied after the potato tubers have been harvested, but typically not later than the onset of sprouting. Thus, in some embodiments of the methods of the invention, sulfuryl fluoride is applied to the tubers within one, two, three, four five, six, seven or eight weeks after the tubers are harvested. Typically, sulfuryl fluoride is applied before the end of the natural dormancy period of the harvested potato tubers, i.e., before the buds on the potato tubers have begun to sprout. Preferably sulfuryl fluoride is applied as close to the end of the natural dormancy period as is practical. The duration of the natural dormancy period is known to those of skill in the art and varies between potato cultivars, and depends on such factors as the physiology and condition of the tubers at harvest, and the storage temperature. For example, depending on temperature and potato cultivar estimates (in days) of the natural dormancy period falls between about 70-140 days at temperatures of 45-48° F.

If potatoes are subject to reconditioning, sulfuryl fluoride is typically applied at the beginning of the reconditioning period. Thus, in some embodiments of the invention, sulfuryl fluoride is applied one, two, three, four or five weeks before potato tubers are processed to make french fries or potato chips. In the practice of the methods of the invention, sulfuryl fluoride may be applied to the potato tubers on more than one occasion (e.g., at least twice) during the storage period.

Typically, but not as a requirement, sulfuryl fluoride is applied simultaneously, or substantially simultaneously, to numerous harvested potato tubers. Potatoes may be stored in bulk storage sheds designed to hold anywhere from, e.g., about 1 ton to about 50,000 tons, more usually about 5000 to 25000 tons. Due to efficiencies of the process using the sulfuryl fluoride in an enclosure containing at least 1 ton of tubers, such as potato tubers is preferred. The sheds are designed to precisely control ventilation through the bulk pile (which may be about twenty five feet deep) along with temperature and relative humidity. Temperature is controlled by refrigeration and/or ventilation with outside air through cell decks which also raises the humidity. For example, sulfuryl fluoride can be applied into the storage ventilation system that circulates air through the potato pile, from bottom to top. The storage sheds are generally closed tight after treatment, and the air may be circulated internally through the pile for several hours after application of the sulfuryl fluoride. Other types of enclosure may be used, preferably enclosures that have humility and temperature controls.

The amount of sulfuryl fluoride that is applied to the potato tubers is preferably an amount effective to inhibit sprouting of the tubers. Sprouting inhibition can vary in the present invention from minimal, but some, inhibition to complete inhibition, including all variations there between.

The amount of sulfuryl fluoride that is effective to inhibit sprouting of the potato tubers depends on the potato cultivar being treated. In some embodiments of the methods of the invention, the sulfuryl fluoride is applied to the potato tubers in an amount sufficient to provide a dosage of from any measurable amount such as 0.001 ppm to, e.g., 50, 100, 200, 500, 1000, etc. ppm. In another embodiment, the concentration of sulfuryl fluoride contacted with the tubers is from about 1 gram per cubic meter of the enclosure the tubers are in, to less than 16 grams per cubic meter. In another embodiment, the concentration of sulfuryl fluoride is from about 2 to 15 grams per cubic meter. In another embodiment, the concentration of sulfuryl fluoride is from about 2 to 14 grams per cubic meter. In another embodiment, the concentration of sulfuryl fluoride is from about 2 to 12 grams per cubic meter. Usually the time period for the contacting is more than two hours. In another embodiment of this invention the time period for the contacting is more than four hours. In another embodiment of this invention the time period for the contacting is more than six hours. In another embodiment of this invention the time period for the contacting is more than eight hours. Generally, the time period is not greater than 1 week. In another embodiment of this invention the time period is not greater than 5 days. In another embodiment of this invention the time period is not greater than 3 days. In another embodiment of this invention the time period is not greater than 2 days.

The methods of the present invention are applicable to any potato cultivar including, but not limited to, Russet Burbank, Ranger Russet, Umatilla Russet, Shepody, Norkotah Russet, Yukon Gold, Norchip, Gem Russet, Atlantic, Chipeta, Snowden, and Dark Red Norland.

### EXAMPLES

These examples are provided to illustrate certain embodiments of this inventions. The invention is not limited to these illustrated embodiments.

### Example 1

Russet and red potatoes were purchased from an organic retail store and used for this study. These potatoes were exposed to 4 treatments (0 gram-hour/cubic meter [g-h/m³], 500 g-h/m³, 1000 g-h/m³ and 1500 g-h/m³) in a Styrofoam™ fumigation chamber. The exposure time was 12 hrs at ambient temperature of approximately 25° C. and relative humidity of 50 percent. Treatment details are listed in Table 1. After exposure time, sulfuryl fluoride was vented and the treated potatoes were observed for their physical features and sprouting (Table 2-8).

TABLE 1
Sulfuryl fluoride fumigation treatment details:

| | | | | Dosage Per | | Cumulative |
|---|---|---|---|---|---|---|
| | | grams of | Time | Interval | Cumulative | Dosage |
| Notes/Actions | Time | SF | Interval | g-h/m³ | Time | g-h/m³ |
| Target: | 18:30 | 0 | 0:00 | 0 | 0:00:00 | 0 |
| 500 g-h/m³ | 18:50 | 46 | 0:20 | 8 | 0:20:00 | 8 |
| Gas introduced at | 21:20 | 46 | 2:30 | 115 | 2:50:00 | 123 |
| 6:30 PM | 6:30 | 40 | 9:10 | 394 | 12:00:00 | 517 |
| Target: | 18:30 | 0 | 0:00 | 0 | 0:00:00 | 0 |
| 1000 g-h/m³ | 18:55 | 87 | 0:25 | 18 | 0:25:00 | 18 |
| Gas introduced at | 21:25 | 86 | 2:30 | 216 | 2:55:00 | 234 |
| 6:30 PM | 6:30 | 83 | 9:05 | 768 | 12:00:00 | 1002 |
| Target: | 18:30 | 0 | 0:00 | 0 | 0:00:00 | 0 |
| 1500 g-h/m³ | 18:45 | 127 | 0:15 | 16 | 0:15:00 | 16 |
| Gas introduced at | 21:35 | 125 | 2:50 | 357 | 3:05:00 | 373 |
| 6:30 PM | 6:30 | 121 | 8:55 | 1097 | 12:00:00 | 1470 |

TABLE 2
Physical and sprouting observations on Russet potatoes treated
with different dosages of sulfuryl fluoride (1 week after exposure)

| Treatment | Avg. No. of | Average length of | |
|---|---|---|---|
| g-h/m³ | Sprouts | sprout (mm) | Tuber firmness |
| Control (0) | 11 | 0-3 | 1 |
| 500 | 1.4 | <1 | 1 |
| 1000 | 0.3 | <1 | 1 |
| 1500 | 0 | 0 | 3 |

Tuber firmness:
1 = firm
2 = slightly spongy
3 = very spongy, probably rotten

TABLE 3
Physical and sprouting observations on Russet potatoes treated
with different dosages of sulfuryl fluoride (2 weeks
after exposure)

| Treatment | Avg. No. of | Average length of | |
|---|---|---|---|
| g-h/m³ | Sprouts | sprout (mm) | Tuber firmness |
| Control (0) | 11.7 | 0-15.9 | 1 |
| 500 | 1.4 | <1 | 1 |
| 1000 | 0.3 | <1 | 1 |
| 1500 | 0 | 0 | 3 |

Tuber firmness:
1 = firm
2 = slightly spongy
3 = very spongy, probably rotten

TABLE 4
Physical and sprouting observations on Russet potatoes treated
with different dosages of sulfuryl fluoride (3 weeks
after exposure)

| Treatment | Avg. No. of | Average length of | |
|---|---|---|---|
| g-h/m³ | Sprouts | sprout (mm) | Tuber firmness |
| Control (0) | 11.7 | 0-35 | 3 |
| 500 | 1.4 | <3 | 2 |

Tuber firmness:
1 = firm
2 = slightly spongy
3 = very spongy, probably rotten

TABLE 5
Physical and sprouting observations on Red potatoes treated
with different dosages of sulfuryl fluoride (1 week after exposure)

| Treatment | Avg. No. of | Average length of | |
|---|---|---|---|
| g-h/m³ | Sprouts | sprout (mm) | Tuber firmness |
| Control (0) | 0 | 0 | 1 |
| 500 | 0 | 0 | 1 |
| 1000 | 0 | 0 | 2 |
| 1500 | 0 | 0 | 3 |

Tuber firmness:
1 = firm
2 = slightly spongy
3 = very spongy, probably rotten

TABLE 6
Physical and sprouting observations on Red potatoes treated with
different dosages of sulfuryl fluoride (2 weeks after exposure)

| Treatment | Avg. No. of | Average length of | |
|---|---|---|---|
| g-h/m³ | Sprouts | sprout (mm) | Tuber firmness |
| Control (0) | 0 | 0 | 1 |
| 500 | 0 | 0 | 1 |
| 1000 | 0 | 0 | 2 |
| 1500 | 0 | 0 | 3 |

Tuber firmness:
1 = firm
2 = slightly spongy
3 = very spongy, probably rotten

TABLE 7
Physical and sprouting observations on Red potatoes treated with
different dosages of sulfuryl fluoride (3 weeks after exposure)

| Treatment | Avg. No. of | Average length of | |
|---|---|---|---|
| g-h/m³ | Sprouts | sprout (mm) | Tuber firmness |
| Control (0) | 3.8 | 0 < 5 | 1 |
| 500 | 1.5 | 0 < 2 | 1 |

Tuber firmness:
1 = firm
2 = slightly spongy
3 = very spongy, probably rotten

TABLE 8
Physical and sprouting observations on Red potatoes treated with
different dosages of sulfuryl fluoride (10 weeks after exposure)

| Treatment | Avg. No. of | Average length of | |
|---|---|---|---|
| g-h/m³ | Sprouts | sprout (mm) | Tuber firmness |
| Control (0) | 8.1 | 0 < 35 | 2 |
| 500 | 1.5 | 0 < 2 | 1 |

Tuber firmness:
1 = firm
2 = slightly spongy
3 = very spongy, probably rotten

### Example 2

A second study was conducted using stored Russet Burbank potatoes. These potatoes were exposed to 3 treatments (O g-h/m3, 300 g-h/m³, and 500 g-h/m³) in a Styrofoam™ fumigation chamber. The exposure time was 12 hrs at ambient temperature of approximately 25° C. and relative humidity of 50 percent. The treatments were replicated 3 times. Each replicate had approximately 10 lbs of potatoes. Treatment details are listed in Table 9. After exposure time, sulfuryl fluoride was vented and the treated potatoes were observed for their physical features and sprouting (Table 10 and 11).

TABLE 9
Sulfuryl fluoride fumigation treatment details:

| | | | | Dosage Per | | Cumulative |
|---|---|---|---|---|---|---|
| | Time | grams | Time | Interval | Cumulative | Dosage |
| Sample | of Reading | SF | Interval | g-h/m3 | Time | g-h/m3 |
| 300 g-h/m3 | 21:40 | 42 | 0:00 | 0 | 0:00:00 | 0 |
| Bag 4 | 22:45 | 42 | 1:05 | 46 | 1:05:00 | 46 |
| | 23:00 | 26 | 0:15 | 9 | 1:20:00 | 54 |
| | 0:15 | 30 | 1:15 | 35 | 2:35:00 | 89 |
| | 6:50 | 47 | 6:35 | 253 | 9:10:00 | 342 |
| 300 g-h/m3 | 21:40 | 40 | 0:00 | 0 | 0:00:00 | 0 |
| Bag 5 | 22:45 | 40 | 1:05 | 43 | 1:05:00 | 43 |
| | 23:00 | 31 | 0:15 | 9 | 1:20:00 | 52 |
| | 0:15 | 32 | 1:15 | 39 | 2:35:00 | 92 |
| | 6:50 | 51 | 6:35 | 273 | 9:10:00 | 365 |
| 300 g-h/m3 | 21:40 | 35 | 0:00 | 0 | 0:00:00 | 0 |
| Bag 6 | 22:45 | 30 | 1:05 | 35 | 1:05:00 | 35 |
| | 23:00 | 27 | 0:15 | 7 | 1:20:00 | 42 |
| | 0:15 | 27 | 1:15 | 34 | 2:35:00 | 76 |
| | 6:50 | 46 | 6:35 | 240 | 9:10:00 | 316 |
| 500 g-h/m3 | 21:40 | 53 | 0:00 | 0 | 0:00:00 | 0 |
| Bag 7 | 22:45 | 52 | 1:05 | 57 | 1:05:00 | 57 |
| | 23:00 | 52 | 0:15 | 13 | 1:20:00 | 70 |
| | 0:15 | 54 | 1:15 | 66 | 2:35:00 | 136 |
| | 6:50 | 65 | 6:35 | 392 | 9:10:00 | 528 |
| 500 g-h/m3 | 21:40 | 49 | 0:00 | 0 | 0:00:00 | 0 |
| Bag 8 | 22:45 | 50 | 1:05 | 54 | 1:05:00 | 54 |
| | 23:00 | 50 | 0:15 | 13 | 1:20:00 | 66 |
| | 0:15 | 52 | 1:15 | 64 | 2:35:00 | 130 |
| | 6:50 | 61 | 6:35 | 372 | 9:10:00 | 502 |
| 500 g-h/m3 | 21:40 | 55 | 0:00 | 0 | 0:00:00 | 0 |
| Bag 9 | 22:45 | 55 | 1:05 | 60 | 1:05:00 | 60 |
| | 23:00 | 54 | 0:15 | 14 | 1:20:00 | 73 |
| | 0:15 | 49 | 1:15 | 64 | 2:35:00 | 138 |
| | 6:50 | 60 | 6:35 | 359 | 9:10:00 | 496 |

TABLE 10
Physical and sprouting observations on Russet Burbank potatoes treated
with different dosages of Sulfuryl fluoride (6 days after exposure).

| Pest Name | | | | | Sprout | Sprout | Sprout | Sprout | Sprout |
|---|---|---|---|---|---|---|---|---|---|
| | | | | | Inhi> | Inhi> | Inhi> | Inhi> | Inhi> |
| Crop Name | | | | | Potato | Potato | Potato | Potato | Potato |
| Crop Variety | | | | | Russet | Russet | Russet | Russet | Russet |
| | | | | | Burb> | Burb> | Burb> | Burb> | Burb> |
| Description | | | | | Number of | Number of | Avg. Number | Avg | Tuber |
| | | | | | potatoes | Sprouts | of sprouts | Length of | Firmness |
| | | | | | | | | sprouts | |
| Part Rated | | | | | Eyes | Eyes | Eyes | Eyes | Tubers |
| Rating Unit | | | | | | | | MM | 0-3 |
| Sample Size | | | | | 10 | 10 | 10 | 10 | 10 |
| Sample Size Unit | | | | | Pounds | pounds | pounds | pounds | pounds |
| Days After First/Last Applic. | | | | | 6 6 | 6 6 | 6 6 | 6 6 | 6 6 |
| Trt-Eval Interval | | | | | 6 DA-A | 6 DA-A | 6 DA-A | 6 DA-A | 6 DA-A |
| Trt | Treatment | | Rate | | | | | | |
| No. | Name | Rate | Unit | Plot | 1 | 2 | 3 | 4 | 5 |
| 1 | Untreated | | | 101 | 21.0 | 158.0 | 7.50 | 1.0 | 0.0 |
| | Check | | | 203 | 21.0 | 162.0 | 7.70 | 1.0 | 0.0 |
| | | | | 302 | 20.0 | 137.0 | 6.90 | 1.0 | 0.0 |
| Mean = | | | | | 20.7 | 152.3 | 7.37 | 1.0 | 0.0 |
| 2 | Sulfuryl | 300 | g-h/m³ | 102 | 21.0 | 0.0 | 0.00 | 0.0 | 0.0 |
| | Fluoride | | | 201 | 18.0 | 0.0 | 0.00 | 0.0 | 0.0 |
| | | | | 303 | 19.0 | 0.0 | 0.00 | 0.0 | 0.0 |
| Mean = | | | | | 19.3 | 0.0 | 0.00 | 0.0 | 0.0 |
| 3 | Sulfuryl | 500 | g-h/m³ | 103 | 19.0 | 0.0 | 0.00 | 0.0 | 0.0 |
| | Fluoride | | | 202 | 20.0 | 0.0 | 0.00 | 0.0 | 0.0 |
| | | | | 301 | 21.0 | 0.0 | 0.00 | 0.0 | 0.0 |
| Mean = | | | | | 20.0 | 0.0 | 0.00 | 0.0 | 0.0 |
| 1 | Untreated | | | | 20.7 A | 152.3 a | 7.37 a | 1.0 a | 0.0 a |
| | Check | | | | | | | | |
| 2 | Sulfuryl | 300 | g-h/m³ | | 19.3 A | 0.0 b | 0.00 b | 0.0 b | 0.0 a |
| | Fluoride | | | | | | | | |
| 3 | Sulfuryl | 500 | g-h/m³ | | 20.0 A | 0.0 b | 0.00 b | 0.0 b | 0.0 a |
| | Fluoride | | | | | | | | |

| | | | | | |
|---|---|---|---|---|---|
| LSD (P = .05) | 2.93 | 17.57 | 0.545 | 0.00 | 0.00 |
| Standard Deviation | 1.29 | 7.75 | 0.240 | 0.00 | 0.00 |
| CV | 6.45 | 15.27 | 9.79 | 0.0 | 0.0 |
| Replicate F | 0.200 | 1.000 | 1.000 | 0.000 | 0.000 |
| Replicate Prob (F) | 0.8264 | 0.4444 | 0.4444 | 1.0000 | 1.0000 |
| Treatment F | 0.800 | 386.043 | 939.270 | 0.000 | 0.000 |
| Treatment Prob (F) | 0.5102 | 0.0001 | 0.0001 | 1.0000 | 1.0000 |

Means followed by same letter do not significantly differ (P = .05, Duncan's New MRT)
Mean comparisons performed only when AOV Treatment P(F) is significant at mean comparison OSL.

TABLE 11
Physical and sprouting observations on Russet Burbank potatoes treated
with different dosages of Sulfuryl fluoride (9 days after exposure)

| Pest Name | | | | Sprout Inhi> | Sprout Inhi> | Sprout Inhi> | Sprout Inhi> |
|---|---|---|---|---|---|---|---|
| Crop Name | | | | Potato | Potato | Potato | Potato |
| Crop Variety | | | | Russet | Russet | Russet | Russet |
| | | | | Burb> | Burb> | Burb> | Burb> |
| Description | | | | Number of | Avg. Number | Avg Length | Tuber |
| | | | | Sprouts | of sprouts | of sprouts | Firmness |
| Part Rated | | | | Eyes | Eyes | Eyes | Eyes |
| Rating Unit | | | | | | | MM |
| Sample Size | | | | 10 | 10 | 10 | 10 |
| Sample Size Unit | | | | pounds | pounds | pounds | pounds |
| Pest Name | | | | Sprout Inhi> | Sprout Inhi> | Sprout Inhi> | Sprout Inhi> |
| Days After First/Last Applic. | | | | 9 9 | 9 9 | 9 9 | 9 9 |
| Trt-Eval Interval | | | | 9 DA-A | 9 DA-A | 9 DA-A | 9 DA-A |
| Trt | Treatment | | Rate | | | | |
| No. | Name | Rate | Unit | 7 | 8 | 9 | 10 |
| 1 | Untreated | | | 192.3 a | 9.33 a | 2.0 a | 0.0 b |
| | Check | | | | | | |
| 2 | Sulfuryl | 300 | g-h/m³ | 0.0 b | 0.00 b | 0.0 b | 1.0 a |
| | Fluoride | | | | | | |
| 3 | Sulfuryl | 500 | g-h/m³ | 0.0 b | 0.00 b | 0.0 b | 1.0 a |
| | Fluoride | | | | | | |

| | | | | |
|---|---|---|---|---|
| LSD (P = .05) | 18.52 | 1.128 | 0.00 | 0.00 |
| Standard Deviation | 8.17 | 0.498 | 0.00 | 0.00 |
| CV | 12.75 | 16.0 | 0.0 | 0.0 |
| Replicate F | 1.000 | 1.000 | 0.000 | 0.000 |
| Replicate Prob (F) | 0.4444 | 0.4444 | 1.0000 | 1.0000 |
| Treatment F | 553.958 | 351.569 | 0.000 | 0.000 |
| Treatment Prob (F) | 0.0001 | 0.0001 | 1.0000 | 1.0000 |

Means followed by same letter do not significantly differ (P = .05, Duncan's New MRT)
Mean comparisons performed only when AOV Treatment P(F) is significant at mean comparison OSL.

As indicated in Table 10 and 11, these treatments stopped sprouts from growing.

### Example 3

A third study was conducted using stored organic Russet potatoes. These potatoes were exposed to 4 treatments (0 g-h/m3, 50 g-h/m³, 100 g-h/m³ 150 g-h/m³ and 200 g-h/m³) in a Styrofoam™ fumigation chamber. The exposure time was 12 hrs at ambient temperature of approximately 25° C. and relative humidity of 50 percent. The treatments were replicated 3 times. Each replicate had approximately 5 lbs of potatoes. After exposure time, and accumulation of proper dosage, sulfuryl fluoride was vented and the treated potatoes were observed for their physical features and sprouting (Table 12, 13 and 14).

TABLE 12
Physical and sprouting observations on Russet Burbank potatoes treated
with different dosages of Sulfuryl fluoride (7 days after exposure)

| Crop Name | | | | Potato | Potato | Potato | Potato |
|---|---|---|---|---|---|---|---|
| Crop Variety | | | | Organic | Organic | Organic | Organic |
| | | | | Russet | Russet | Russet | Russet |
| Description | | | | Number of | Avg. Number | Avg Length | Tuber |
| | | | | Sprouts | of sprouts | of sprouts | Firmness |
| Part Rated | | | | Eyes | Eyes | Eyes | Eyes |
| Rating Unit | | | | | | | MM |
| Sample Size | | | | 5 | 5 | 5 | 5 |
| Sample Size Unit | | | | pounds | pounds | pounds | pounds |
| Pest Name | | | | Sprout Inhi> | Sprout Inhi> | Sprout Inhi> | Sprout Inhi> |
| Days After First/Last Applic. | | | | 7 7 | 7 7 | 7 7 | 7 7 |
| Trt-Eval Interval | | | | 7 DA-A | 7 DA-A | 7 DA-A | 7 DA-A |
| Trt | Treatment | | Rate | | | | |
| No. | Name | Rate | Unit | | | | |
| 1 | Untreated | | | 172.0 | 9.13 | 3.0 | 0.0 |
| | Check | | | | | | |
| 2 | Sulfuryl | 50 | g-h/m³ | 60.0 | 3.00 | 1.1 | 0.0 |
| | Fluoride | | | | | | |
| 3 | Sulfuryl | 100 | g-h/m³ | 52.0 | 1.9 | 1.0 | 0.0 |
| | Fluoride | | | | | | |
| 4 | Sulfuryl | 150 | g-h/m³ | 17.0 | 0.3 | 0.2 | 0.0 |
| | Fluoride | | | | | | |
| 5 | Sulfuryl | 200 | g-h/m³ | 0 | 0 | 0 | 0.0 |
| | Fluoride | | | | | | |

TABLE 13
Physical and sprouting observations on Russet Burbank potatoes treated
with different dosages of Sulfuryl fluoride (21 days after exposure)

| Crop Name | | | | Potato | Potato | Potato | Potato |
|---|---|---|---|---|---|---|---|
| Crop Variety | | | | Organic | Organic | Organic | Organic |
| | | | | Russet | Russet | Russet | Russet |
| Description | | | | Number of | Avg. Number | Avg Length | Tuber |
| | | | | Sprouts | of sprouts | of sprouts | Firmness |
| Part Rated | | | | Eyes | Eyes | Eyes | Eyes |
| Rating Unit | | | | | | | MM |
| Sample Size | | | | 5 | 5 | 5 | 5 |
| Sample Size Unit | | | | pounds | pounds | pounds | pounds |
| Pest Name | | | | Sprout Inhi> | Sprout Inhi> | Sprout Inhi> | Sprout Inhi> |
| Days After First/Last Applic. | | | | 21 | 21 | 21 | 21 |
| Trt-Eval Interval | | | | 21 DA-A | 21 DA-A | 21 DA-A | 21 DA-A |
| Trt | Treatment | | Rate | | | | |
| No. | Name | Rate | Unit | | | | |
| 1 | Untreated | | | 190.0 | 9.5 | 13.0 | 1.0 |
| | Check | | | | | | |
| 2 | Sulfuryl | 50 | g-h/m³ | 126.0 | 6.3 | 9.1 | 1.0 |
| | Fluoride | | | | | | |
| 3 | Sulfuryl | 100 | g-h/m³ | 88.0 | 2.4 | 6.5 | 1.0 |
| | Fluoride | | | | | | |
| 4 | Sulfuryl | 150 | g-h/m³ | 17.0 | 0.3 | 0.2 | 0.0 |
| | Fluoride | | | | | | |
| 5 | Sulfuryl | 200 | g-h/m³ | 0 | 0 | 0 | 0.0 |
| | Fluoride | | | | | | |

TABLE 14
Physical and sprouting observations on Russet Burbank potatoes treated
with different dosages of Sulfuryl fluoride (31 days after exposure)

| Crop Name | | | | Potato | Potato | Potato | Potato |
|---|---|---|---|---|---|---|---|
| Crop Variety | | | | Organic | Organic | Organic | Organic |
| | | | | Russet | Russet | Russet | Russet |
| Description | | | | Number of | Avg. Number | Avg Length | Tuber |
| | | | | Sprouts | of sprouts | of sprouts | Firmness |
| Part Rated | | | | Eyes | Eyes | Eyes | Eyes |
| Rating Unit | | | | | | | MM |
| Sample Size | | | | 5 | 5 | 5 | 5 |
| Sample Size Unit | | | | pounds | pounds | pounds | pounds |
| Pest Name | | | | Sprout Inhi> | Sprout Inhi> | Sprout Inhi> | Sprout Inhi> |
| Days After First/Last Applic. | | | | 21 | 21 | 21 | 21 |
| Trt-Eval Interval | | | | 21 DA-A | 21 DA-A | 21 DA-A | 21 DA-A |
| Trt | Treatment | | Rate | | | | |
| No. | Name | Rate | Unit | | | | |
| 1 | Untreated | | | 190.0 | 9.5 | 23.0 | 2.0 |
| | Check | | | | | | |
| 2 | Sulfuryl | 50 | g-h/m³ | 126.0 | 6.3 | 21.1 | 2.0 |
| | Fluoride | | | | | | |
| 3 | Sulfuryl | 100 | g-h/m³ | 88.0 | 2.4 | 16.5 | 1.0 |
| | Fluoride | | | | | | |
| 4 | Sulfuryl | 150 | g-h/m³ | 17.0 | 0.3 | 1.2 | 0.0 |
| | Fluoride | | | | | | |
| 5 | Sulfuryl | 200 | g-h/m³ | 0 | 0 | 0 | 0.0 |
| | Fluoride | | | | | | |

As presented in Table 13, the sprout inhibition was dose dependent. The 50 g-h/m³ and 100 g-h/m³ treatments had significant sprout growth 21 DAT when compared to the 150 g-h/m³ and 200 gh/m³ treatments. The 150 g-h/m³ treatment had a slight sprout growth 7 DAT; however, the sprout did not grow further during the 21 DAT observations. The peel testing indicated that none of the treatments used in this study produced the black spot as observed in the previous study. The 200 g-h/m³ treatments resulted in best sprout inhibition, even after 31 days without any phyto-toxic effects.

What is claimed is:

1. A process for inhibiting sprouting in tubers, after said tubers are harvested, and after said tubers are placed in an enclosure, said process comprising contacting sulfuryl fluoride with said tubers for a time period greater than two hours, wherein the concentration of said sulfuryl fluoride in said enclosure is from about 1 gram per cubic meter of said enclosure but less than 16 grams per cubic meter of said enclosure.

2. A process according to claim 1 wherein said concentration of said sulfuryl fluoride is from about 2 to about 15 grams per cubic meter.

3. A process according to claim 1 wherein said concentration of said sulfuryl fluoride is from about 2 to about 14 grams per cubic meter.

4. A process according to claim 1 wherein said concentration of said sulfuryl fluoride is from about 2 to about 12 grams per cubic meter.

5. A process according to claim 1 wherein said time period greater than about 4 hours.

6. A process according to claim 1 wherein said time period is greater than about 6 hours.

7. A process according to claim 1 wherein said time period is greater than about 8 hours.
